(19) United States
(12) Patent Application Publication
(10) Pub. No.: US 2016/0334528 A1
(43) Pub. Date: Nov. 17, 2016

(54) SYSTEMS AND METHODS FOR CHARACTERIZING SUBTERRANEAN FORMATIONS UTILIZING AZIMUTHAL DATA

(71) Applicant: CGG SERVICES SA, Massy (FR)

(72) Inventors: Bernard DESCHIZEAUX, Aberdeen (GB); Jonathan HABERFIELD, Crawley (GB)

(21) Appl. No.: 15/107,150

(22) PCT Filed: Dec. 5, 2014
(86) PCT No.: PCT/IB2014/003044

§ 371 Date: Jun. 22, 2016

Related U.S. Application Data
(60) Provisional application No. 61/922,211, filed on Dec. 31, 2013.
(60) Provisional application No. 61/929,170, filed on Jan. 20, 2014.

(51) Int. Cl. G01V 1/30; G01V 1/36; G01V 1/32

(52) U.S. Cl. CPC G01V 1/306; G01V 1/32; G01V 1/36; G01V 2210/626

(57) ABSTRACT

A system and method is disclosed for characterizing a subterranean formation utilizing azimuthal data that includes obtaining seismic data along a plurality of azimuth angles from a receiver and performing a correction to the seismic data to remove an offset effect. The offset effect is based on a distance between the receiver and a seismic source. The method further includes analyzing the corrected seismic data for an anisotropic region indicative of a subterranean fracture.

### CROSS-REFERENCE TO RELATED APPLICATIONS

The present application claims the benefit of priority under 35 U.S.C. §119 from U.S. Provisional Patent Application Serial No. 61/929,170, filed on Jan. 20, 2014, and U.S. Provisional Patent Application Serial No. 61/922,211, filed on Dec. 31, 2013, which are incorporated by reference in their entirety for all purposes.

### TECHNICAL FIELD

The present disclosure relates generally to seismic exploration and, more particularly, to characterizing subterranean formations using azimuthal data.

### BACKGROUND

Seismic surveying or seismic exploration, whether on land or at sea, is accomplished by generating a seismic energy signal that propagates into the earth. Propagating seismic energy is partially reflected, refracted, diffracted and otherwise affected by one or more geologic structures within the earth, for example, by interfaces between underground formations having varying acoustic impedances. The affected seismic energy is detected by receivers, or seismic detectors, placed at or near the earth's surface, in a body of water, downhole in a wellbore, or on a sea floor. The resulting signals are recorded and processed to generate information relating to the physical properties of subsurface formations. Detection and characterization of fractures and associated anisotropy in subsurface formations indicates the presence or absence of probable locations of hydrocarbon deposits.

Unconventional hydrocarbon reservoirs are reservoirs that do not meet the criteria for conventional production. For example, an unconventional reservoir may present a challenge for production because of adverse porosity, permeability or other characteristics. Examples of unconventional reservoirs include coalbed methane, gas hydrates, shale gas, fractured reservoirs, and tight gas sands.

Production from unconventional reservoirs may depend on the presence of natural fractures in the reservoir. Fractured regions in an unconventional reservoir may be filled with readily extractable hyrdocarbons. Finding the fractures in unconventional reservoirs can be important for drilling wells that will be economically producible. Conversely, natural fractures can also represent hazards to drilling if they are water filled. The identification and characterization of naturally fractured zones in an unconventional reservoir can therefore be vital for successful and safe exploitation of the reservoir. Identification of fractured zones is not only highly useful in exploration but can also be useful for infill drilling in an existing field, that is to say the drilling of additional wells between existing production wells to target bypass reservoirs.

One approach to finding naturally fractured zones is seismic analysis that identifies seismically anisotropic regions within the reservoir. Anisotropy of a subterranean formation is defined as the property of having different physical characteristics (for example, seismic wave velocity) in different directions. A fractured region of a reservoir exhibits seismic anisotropy since properties such as seismic wave velocities may be different along the direction of the fractures compared with the direction orthogonal to the fractures.

Some approaches to determine anisotropic regions use the amplitude versus azimuth angle (AVAz) analysis. This analysis involves obtaining a large amount of seismic data from many different azimuth angles. Azimuth is defined as the angle in a horizontal plane between the seismic source and the place where the reading is taken, relative to some datum angle, for example north. The amplitude is a measure of reflectivity of seismic waves. Seismic readings are also taken for different offsets (distance along the ground between source and reading) on each azimuth angle to improve the signal to noise ratio of the data. An analysis of the data may further include generating plots of amplitude versus offset (AVO).

One goal of AVAz analysis is to determine the amplitude change due to azimuth anisotropy. Values of azimuth anisotropy may then be obtained for different locations and may be plotted as a graphic representation of the region, which can be for example a map, a cross section through the depth of the reservoir or a three dimensional image. Inspection of the image can reveal the presence of anomalies, which may represent zones with a high degree of natural fracturing. However, the resultant images are difficult to read and analyze for anisotropic regions, which indicate fracturing and fracture direction. Thus, there is a need for a technique to improve identification and analysis of anisotropic regions, natural fractures, and fracture direction.

### SUMMARY

In accordance with one or more embodiments of the present disclosure, a method for characterizing a subterranean formation utilizing azimuthal data includes obtaining seismic data along a plurality of azimuth angles from a receiver and performing a correction to the seismic data to remove an offset effect. The offset effect is based on a distance between the receiver and a seismic source. The method further includes analyzing the corrected seismic data for an anisotropic region indicative of a subterranean fracture

In accordance with another embodiment of the present disclosure, a seismic processing system includes a receiver configured to receive seismic data. The system includes a computing system configured to obtain seismic data along a plurality of azimuth angles from the receiver and perform a correction to the seismic data to remove an offset effect. The offset effect is based on a distance between the receiver and a seismic source. The computing system is further configured to analyze the corrected seismic data for an anisotropic region indicative of a subterranean fracture.

In accordance with another embodiment of the present disclosure, non-transitory computer-readable storage medium including computer-executable instructions carried on the computer-readable medium. The instructions, when executed, cause a processor to obtain seismic data along a plurality of azimuth angles from a receiver and perform a correction to the seismic data to remove an offset effect. The offset effect is based on a distance between the receiver and a seismic source. The processor is further caused to analyze the corrected seismic data for an anisotropic region indicative of a subterranean fracture.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a schematic diagram of an example ocean bottom cable (OBC) acquisition exploration area in accordance with some embodiments of the present disclosure;

FIG. 2 illustrates a graph of an amplitude versus offset (AVO) plot in accordance with some embodiments of the present disclosure;

FIG. 3 illustrates a graph of flattening of amplitude data shown in

FIG. 3 in accordance with some embodiments of the present disclosure;

FIGS. 4A-4C illustrate example amplitude versus azimuth (AVAz) plots for a synthetic anisotropic reflection in accordance with some embodiments of the present disclosure;

FIG. 5A illustrates an example AVAz plot for synthetic data in accordance with some embodiments of the present disclosure;

FIG. 5B illustrates a bar chart of the Fourier amplitude as a function of mode of the irregular Fourier transform (IFT) of seismic data used to generate an AVAz plot shown in FIG. 5A in accordance with some embodiments of the present disclosure;

FIG. 6 illustrates a bar chart of the Fourier amplitude of each mode of a Fourier transform performed on an example set of seismic data in accordance with some embodiments of the present disclosure;

FIG. 7 illustrates an elevation view of an example seismic exploration system in accordance with some embodiments of the present disclosure; and

FIG. 8 illustrates a flow chart of an example method of characterizing a subterranean formation to identify anisotropic behavior utilizing azimuthal data in accordance with some embodiments of the present disclosure.

### DETAILED DESCRIPTION

Naturally fractured zones are important in seismic surveying because fractures may indicate the presence of hydrocarbon deposits. Thus, some seismic surveys are focused on discovering fractures in the subsurface formations. Fractured regions may be filled with readily extractable gas or oil and are significant for drilling wells that are economically producible. However, natural fractures also represent hazards to drilling if they are water filled. Therefore, the identification and characterization of naturally fractured zones is useful for seismic surveys.

Fractures may be identified by discovering seismically anisotropic regions within a subsurface formation. Anisotropy of a subsurface formation is the property of having different physical characteristics, for example seismic wave velocity, in different directions. As such, fractures may display seismic anisotropy since properties, such as seismic wave velocities, are different along the direction of the fractures compared with the direction orthogonal, or perpendicular, to the fracture. For example, seismic waves may travel quickly along the direction of fractures and slower in other directions. Based on careful retention and analysis of data, anisotropic regions, and thus fractures may be identified and characterized. Anisotropic regions may be discovered by the utilization of amplitude versus azimuth (AVAz) plots of the seismic data. Amplitude reflects the amount of displacement of a seismic reflection and indicates the relative strength of a received signal. Thus, the change in amplitude as a function of azimuth identifies anisotropic regions and associated fractures. However, AVAz plots may be difficult to analyze and identify anisotropic regions, and thus natural fractures. Processing the AVAz data utilizing advanced processing techniques, including Fourier transforms, may assist in analyzing and identifying anisotropic regions in azimuthal data.

In some embodiments, processing AVAz data results in data organized based on Fourier modes. Transitioning the AVAz data into data organized based on Fourier modes may be referred to as “azimuthal decomposition” or “decomposition.” Analysis performed on the decomposition data can include removing artifacts due to acquisition geometry, identifying anisotropic areas, or other suitable analysis.

Reversing the azimuthal decomposition process based on selection of particular Fourier modes, may be referred to as “azimuthal reconstruction” or “reconstruction.” Reconstruction results in seismic data that allows for improved identification of anisotropic regions and improved ability to identify the origin of a particular feature discovered during decomposition. Additionally, reconstruction may allow for additional processing of the azimuthal data such as high frequency denoising, modes attenuation, or other suitable analysis processes.

To assist in detection of fractured regions, a seismic survey may be repeated at various time intervals, for example, months or years apart, to examine any changes in the reservoirs, referred to as 4D processing, time lapse acquisition and processing, or reservoir monitoring. Data collected during a seismic survey includes traces that are gathered, processed, or utilized to generate a model of the subsurface formations.

Seismic processing methods utilize receivers to acquire a series of traces (or a “gather” or multiple “gathers” of traces) reflected from the same common subsurface point, such as a common mid-point (CMP) gather. A common mid-point may be an incident point on a subsurface interface at which a seismic wave reflects. A common mid-point lies equidistant between a particular source and a particular receiver, and may also provide a common depth point (CDP). A subsurface interface may include a rock layer interface or any other subsurface interface where the density or composition of a layer of the subsurface changes. The traces are then summed (or “stacked”). Stacking multiple traces improves the signal-to-noise ratio (SNR) over “single-fold” stack results. The “fold” indicates the number of traces in a CMP gather. Further, additional gather types may be utilized in data processing, such as common shot gather (one source or shot received by multiple receivers), common receiver gather (multiple sources received by one receiver) (CRG), common conversion point (CCP) or any other suitable types

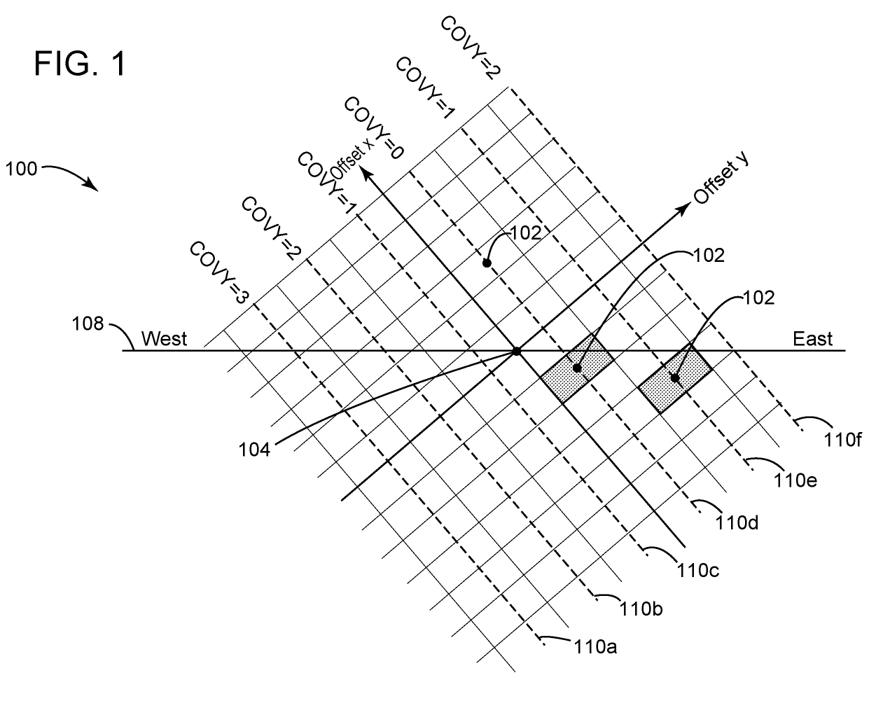

Embodiments of the present invention and its advantages are best understood by referring to FIGS. 1 through 8 of the drawings, like numerals being used for like and corresponding parts of the various drawings.

FIG. 1 illustrates a schematic diagram of an example ocean bottom cable (OBC) acquisition exploration area 100 in accordance with some embodiments of the present disclosure. A survey of the acquisition area typically includes activation of a seismic source that radiates an elastic wavefield that expands downwardly through the layers beneath the earth's surface. The seismic wavefield is reflected, refracted, or otherwise returned from the respective layers as a wavefront or head wave recorded by receivers 102. In some embodiments, source 104 is controlled to generate seismic waves in a seismic survey, and receivers 102 receive waves reflected by subsurface layers, oil or gas reservoirs, or other subsurface formations. Area 100 includes multiple strings 110a-110f containing multiple receivers configured in a grid along an x-axis and spaced apart along a y-axis. The distance between a particular receiver 102 in a particular string 110 and source 104 may be expressed in terms of common offset vector (COV) geometry. COV geometry may be a function of the respective offset-x and offset-y for the particular receiver. In some embodiments, area 100 to be surveyed may have an irregular geometry, for example in “patch” surveys or acquisitions.

In some embodiments, OBC data (such as data from area 100) or land data includes data associated with a large azimuthal area. In some embodiments, the azimuthal data may be utilized to ascertain anisotropic information of the subsurface formation. Azimuth is the angle in a horizontal plane between a particular seismic source 102 and a particular receiver relative to some datum angle. For example, datum 108 is configured in an East-West orientation with East representing approximately zero degrees, and receiver 102 located on string 110d has an azimuth of approximately 134 degrees. With OBC acquisition geometry, such as area 100, a wide range of azimuths are preserved during imaging by using COV geometry.

As discussed previously, the detection of anisotropic features can indicate the presence of a subterranean fracture because of the differing propagation velocities parallel and perpendicular to the direction of the fracture. Information gained by analysis of data based on COV geometry, also referred to as azimuthal information, is utilized to generate AVAz plots and assist in determining details regarding fractures, fractured reservoirs, and associated anisotropic properties.

In some embodiments, a portion of the data set is selected for analysis based on an incidence angle range. The incidence angle is the acute angle that a raypath makes with the normal to a subsurface interface. In the anisotropic case, the incidence angle is the angle between the raypath and the normal, the raypath not necessarily being perpendicular to the wavefront. For example, incidence angles from approximately five to forty degrees may be selected. In some embodiments, incidence angles up to approximately sixty degrees or larger may be selected. Selection of incidence angles can be based on computing capabilities, expected direction of fractures, or any other suitable constraint.

In some embodiments, a seismic data processing sequence that incorporates a method to provide quality control to an azimuth dataset to extract anisotropic information may be useful. Further, analyzing the AVAz plots assists in denoising the data while retaining the azimuthal information, performing 4D matching in an azimuthal controlled way, or detecting multiple residuals.

Generating AVAz plots involves obtaining seismic data from different azimuth angles at different offsets for each azimuth angle. Analysis is made of the gathered seismic data utilizing a linearized Rüger equation as follows:

R=R₀+Gsin²θ+Acos2(φ−φ₀)sin²θ (1)

where:

R₀=intercept (seismic amplitude for approximately zero offset);

G=gradient (variation of seismic amplitude with angle);

A=amplitude of anisotropy;

φ=azimuth angle;

φ₀=symmetry axis (perpendicular to the fracture direction); and

θ=incidence angle.

For a seismic survey, amplitude of a seismic reflection is affected by offset, which is the distance between source 104 that generated the seismic signal and receiver 102 that received the reflected signal. The change in amplitude as a function of offset is represented in amplitude versus offset (AVO) plots. An AVO plot assists in analysis to determine thickness, porosity, density, seismic velocity, lithology, fluid content, and other characteristics of subsurface layers. As such, amplitude behavior depends on both offset and azimuth and the effect of each on amplitude is difficult to separate.

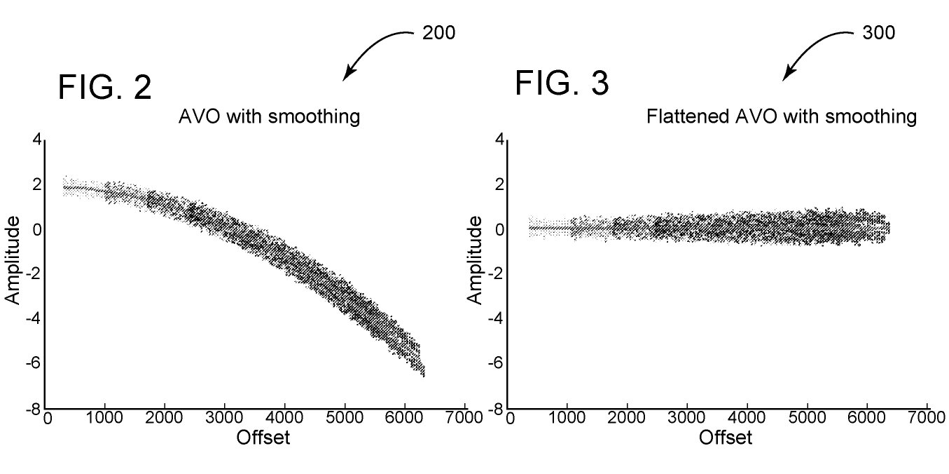

FIG. 2 illustrates graph 200 of an amplitude versus offset (AVO) plot in accordance with some embodiments of the present disclosure. As can be seen in graph 200, the amplitude of the received signal decreases as offset increases. However, in some embodiments, the amplitude may initially be negative at approximately zero offset and gradually increase and become positive as offset increases. Further, the amplitude shown in graph 200 may be based on smoothing of the data. Smoothing is based on any statistical process for minimizing outliers and noise such as moving averages, convolution, filtering, or any other suitable statistical processing.

Based on the interaction between offset and azimuth effect on amplitude, it is advantageous to remove the offset effect or influence from the data. The resultant residual amplitude then depends only on azimuth and is easier to characterize. In some embodiments, two steps are utilized to remove the offset influence from the data set. The data set is “flattened,” which includes subtracting the average amplitude, or subtracting the AVO trend (intercept and gradient) from the data. Accordingly, FIG. 3 illustrates a graph 300 of flattening of amplitude data shown in FIG. 2 in accordance with some embodiments of the present disclosure. In graph 300, the gradient and intercept information are removed from the data.

After flattening, the data is then divided by a correction factor to remove the effect of the incidence angle, minimize sources of noise, or remove remaining dependency on offset. For example, the flattened data may be divided by sin²θ where θ is the incidence angle. As another example, the flattened data may be divided by 1/sin²θ where θ is the incidence angle.

In some embodiments, Equation (1) shown above reflects the original data. Subtraction of the AVO trend, or flattening, includes removing the intercept and gradient from the equation. Thus, the data after flattening is shown by the following equation:

R=Acos2(φ−φ₀)sin²θ (2).

After dividing by sin²θ the data is shown by the equation:

R=Acos2(φ−φ₀) (3).

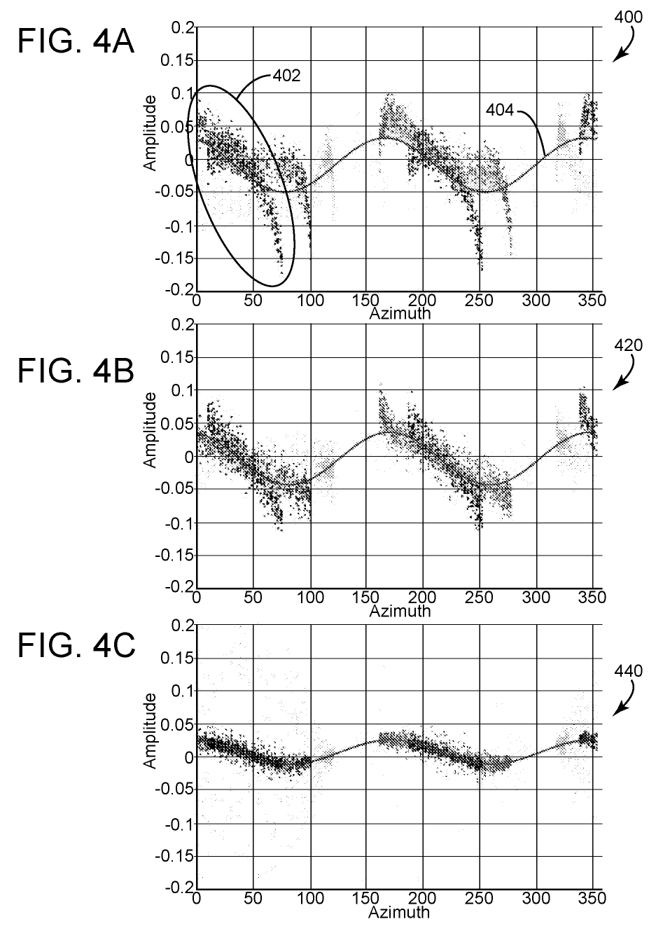

FIGS. 4A-4C illustrate example AVAz plots 400, 420 and 440 for a synthetic anisotropic reflection in accordance with some embodiments of the present disclosure. FIG. 4A illustrates plot 400 of initial received data based on COV offset-y (COVY) values. For example, each grouping 402 is based on receivers associated with one string 110 shown with reference to FIG. 1. Line 404 is fit to Equation (3) above. FIG. 4B illustrates plot 420 of initial received data after flattening based on Equation (2) above. FIG. 4C illustrates plot 440 of flattened data after sin²θ correction. Plot 440 may further have noise removed with additional processing to remove outliers, such as with an offset cut.

In some embodiments, the residual AVAz plot from FIG. 4C or after additional processing is analyzed to detect azimuthal bias. For example, a Fourier transform may be utilized to decompose the amplitude azimuthal behavior into frequency mode and to generate a series of discrete periodic functions. Fourier analysis is the process of decomposing a function of time or space into a sum (or integral) of sinusoidal functions (sines or cosines) with specific amplitudes and phases. A Fourier transform is a set of mathematical formulas used to convert a function, such as a seismic trace, to a function in the frequency domain. For example, a Fourier transform may be performed to convert the azimuthal domain to the frequency domain. A Fast Fourier Transform (FFT) is an iterative computer program to perform the Fourier transform of digitized waveforms rapidly.

By decomposing the data in the azimuthal domain, description of the data is not restricted to following the Rüger model of anisotropy, but instead allows description of any azimuthal behavior that exists in the dataset. The Fourier transform identifies azimuthal biases in the data set and produces two relevant modes of data that describe azimuthal amplitude variation, the second and fourth modes or harmonics. The analysis involves interpretation of the different modes produced by the Fourier transform and comparing them to the theory (Rüger equation for example) to assess the quality of the data. The m^{th} Fourier mode (m=0,1,2, . . .) represents an AVAz-domain term of kcos[m(φ−α)] where α and k are constants and are the amplitude and phase, respectively, of the m^{th} Fourier coefficient. If the Rüger equation is obeyed, then the residual amplitude may be shown by Equation (3) above. Therefore, mode two represents the amplitude and direction of azimuthal anisotropy. Additionally, mode four may be significant because the Rüger equation is only an approximation. Because the Rüger equation may only explain modes two and four, the other modes may represent biases to the azimuthal information to be identified, as such, other modes may provide a quality control check on the azimuthal data. For example, energy present in other modes may indicate that the azimuthal data is biased and may need correction.

In some embodiments, an irregular Fourier transform (IFT) is utilized when the azimuthal domain is not uniformly sampled. The IFT minimizes spectral leakage of the Fourier transform. Spectral leakage refers to the misrepresentation of the Fourier components of the signal that are not harmonic to the fundamental frequency. Furthermore, high frequency variations of amplitude are related to noise. Therefore, limiting the decomposition to the first ten or twenty modes is sufficient to analyze azimuthal data.

Limiting the number of modes allows the irregular Fourier transform to be more efficient in terms of processing time and allows the analysis to be employed at various processing stages. In practice, all datasets contain noise that is present in all modes. Residual multiples in OBC geometries, for example, do not follow the azimuthal reciprocity and thus, may have some component in the odd modes. Further, artifacts and biases, which have an anisotropic component, mask or reinforce genuine anisotropy depending on their relative direction.

The analysis may be applied at different stages of the seismic processing to assist in parameter decision making, perform quality control (QC) checks of the data and preserve the azimuthal information. In some embodiments, stages in processing include migration, residual move out (RMO), wavelet decay curve matching, post stack residual de-multiple, 4D OVT matching, spectra offset balancing, trim statics, and AVO. For example, the analysis may be performed before post stack residual de-multiple processing, before or after spectra offset balancing processing, after final processing, or at any other suitable stage of processing.

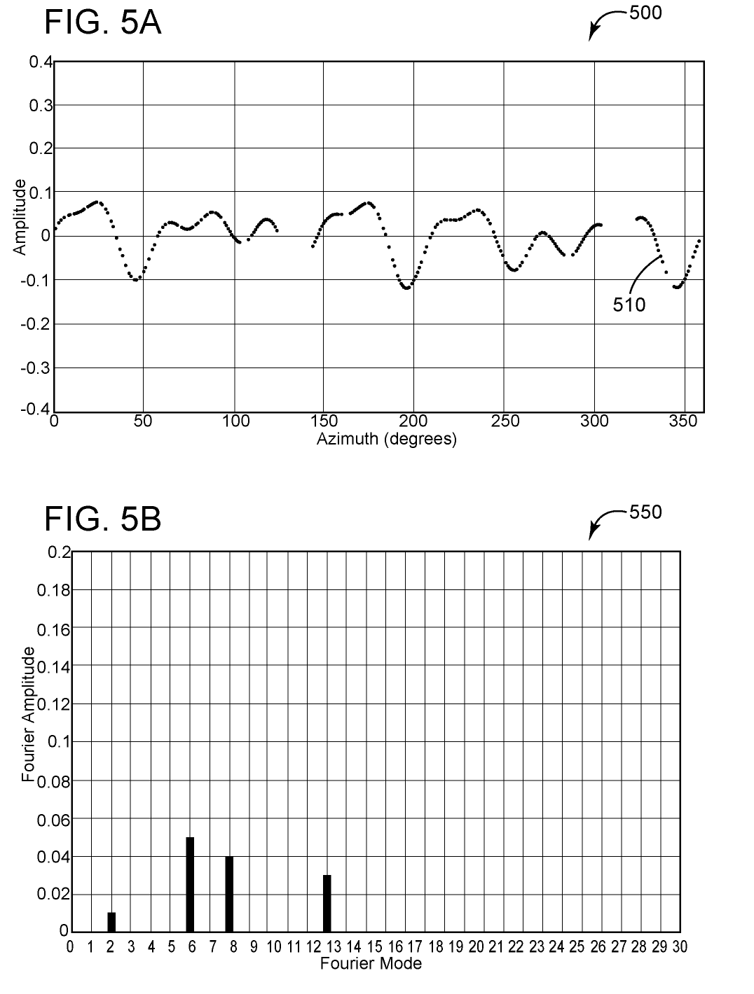

FIG. 5A illustrates an example AVAz plot 500 for synthetic data in accordance with some embodiments of the present disclosure. Amplitude 510 is irregularly sampled based upon the location of strings and receivers. Thus, amplitude 510 includes azimuths in which no signal was detected. The irregularity of amplitude 510 may indicate that an IFT rather than an FFT provides the best characterization of azimuthal data.

FIG. 5B illustrates bar chart 550 of the Fourier amplitude as a function of mode of the IFT of seismic data used to generate AVAz plot 500 shown in FIG. 5A in accordance with some embodiments of the present disclosure. The IFT is selected for this analysis based on the irregular sampling of the data and to minimize spectral leakage. Only modes one, five, seven and twelve have sufficient amplitude. The coefficients derived from the analysis and resultant equation may be expressed as:

R=0.01sin(φ−π/9)+0.05sin(5φ)+0.04sin(7φ)+0.03cos(12φ) (4).

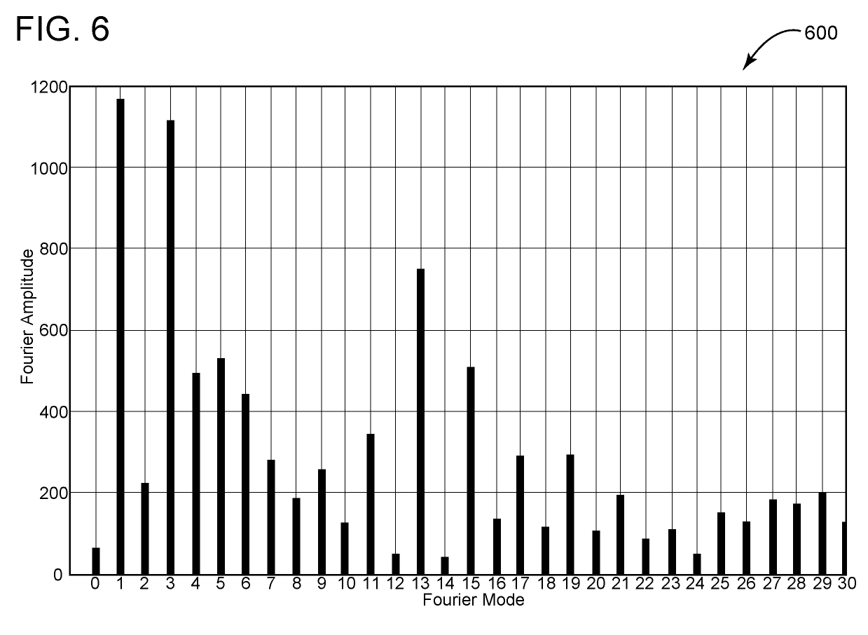

FIG. 6 illustrates bar chart 600 of the Fourier amplitude of each mode of a Fourier transform performed on an example set of seismic data in accordance with some embodiments of the present disclosure. In the Fourier analysis of the seismic data set used to create bar chart 600, mode two has a significantly lower Fourier amplitude than modes one and three. Thus, the anisotropy component of the seismic data set is small. Thus, analysis of modes of either a regular or an irregular Fourier transform indicate whether the selected data set includes anisotropic regions.

In some embodiments, calculating and outputting the amplitude and phase of each Fourier mode provides information relating to anisotropic properties. Corrections are made to the data based on gaps in azimuthal coverage. Corrections include lowering the offset/angle threshold for the data, scaling the root mean squared (RMS) output, forcing some modes, for example mode zero, to zero, smoothing the data, or any other suitable corrections.

In some embodiments, subsurface images are generated for modes of the irregular Fourier transform. For example, the first five modes may be generated as images. In certain modes, for example mode two, events in the form of visible traces, may appear on the images and may indicate anisotropic regions per Rüger's theory.

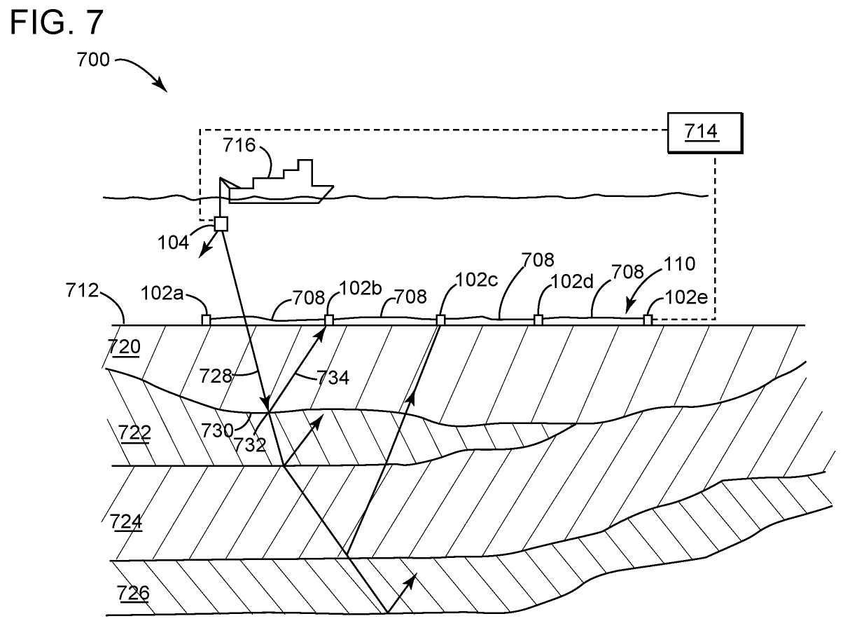

FIG. 7 illustrates an elevation view of an example seismic exploration system 700 in accordance with some embodiments of the present disclosure. System 700 is configured to produce imaging of the earth's subsurface geological formations. System 700 includes one or more seismic energy sources 104 and one or more receivers 102 located within an exploration area. The exploration area is any defined area selected for seismic survey or exploration, for example area 100 shown with reference to FIG. 1.

Receiver 102 is located on or proximate to surface of the earth or ocean floor 712 within the exploration area. Receiver 102 may be located on land or located on the ocean bottom via an OBC. Receiver 102 is any type of instrument that is utilized to transform seismic energy or vibrations into a voltage signal. Receiver 102 detects movements from energy waves below ocean floor 712 and converts the movements into electrical energy, such as electric voltages. For example, receiver 102 may comprise a hydrophone configured to detect or record energy waves reflected from subsurface formations. Receiver 102 may be a vertical, horizontal, or multicomponent hydrophone. For example, receiver 102 may be a three component (3C) hydrophone, a 3C geophone, a 3C accelerometer, a 3C Digital Sensor Unit (DSU), or any suitable 3C receiver. Multiple receivers 102 are typically used within the exploration to provide data related to multiple locations and distances from sources 104. For example, system 700 might utilize two hundred receivers (or geophones) 102. Receivers 102 may be positioned in multiple configurations, such as linear, grid, array, or any other suitable configuration. In some embodiments, receivers 102 are positioned along one or more strings 110. Each receiver 102 is spaced apart from adjacent receivers 102 in the same string 110. Spacing 708 between receivers 102 in string 110 may be approximately the same preselected distance, or span, or spacing 708 may vary depending on a particular application, the topology of the exploration area, or any other relevant parameter. For example, spacing 708 may be approximately ten meters. Further, multiple strings 110 are spaced apart by the same preselected distance. For example, spacing between strings 110 is approximately fifty meters.

In some embodiments, system 700 includes one or more seismic energy sources 104. Seismic energy source 104 may be referred to as an acoustic source, seismic source, energy source, or source 104. In some embodiments, for example seismic surveys on land, source 104 is located on or proximate to the surface of the earth within the exploration area. In other embodiments, such as seismic surveys at sea, source 104 is towed behind vessel 716. A particular source 104 is spaced apart from other adjacent sources 104. Source 104 are typically operated by a central controller that coordinates the operation of several sources 104. Further, a positioning system, such as a global positioning system (GPS), may be utilized to locate or time-correlate sources 104 and receivers 102.

Source 104 is any type of seismic device that generates controlled seismic energy used to perform reflection or refraction seismic surveys, such as dynamite, an air gun, a thumper truck, a seismic vibrator, vibroseis, or any other suitable seismic energy source. For example, source 104 may be an impulsive energy source such as an air gun. With an impulsive energy source, a large amount of energy is injected into the surrounding media in a very short period of time.

In order to record and analyze data, sources 104 and receivers 102 are communicatively coupled to one or more computing devices 714. One or more receivers 102 transmit raw seismic data from received seismic energy via a network to computing device 714. A particular computing device 714 can also transmit raw seismic data to other computing devices 714 or other sites via a network. Computing device 714 performs seismic data processing on the raw seismic data to prepare the data for interpretation. Computing device 714 may include any instrumentality or aggregation of instrumentalities operable to compute, classify, process, transmit, receive, store, display, record, or utilize any form of information, intelligence, or data. For example, computing device 714 may be a personal computer, a storage device, or any other suitable device and may vary in size, shape, performance, functionality, and price. Computing device 714 may include random access memory (RAM), one or more processing resources such as a central processing unit (CPU) or hardware or software control logic, or other types of volatile or non-volatile memory. Additional components of computing device 714 may include one or more disk drives, one or more network ports for communicating with external devices, various input and output (I/O) devices, such as a keyboard, a mouse, and a video display. Computing device 714 may be located in a station truck or any other suitable enclosure. Computing device 714 is configured to permit communication over any type of network, such as a wireless network, a local area network (LAN), or a wide area network (WAN) such as the Internet.

During operation, seismic waves radiate from source 104 and are reflected from subsurface layers 720-726 to receivers 102. For example, a seismic wave radiating from source 104 propagates along trajectory 728. The seismic wave on trajectory 728 reflects from interface 730 at incident point or mid-point 732. Interface 730 may comprise a rock layer interface or any other subsurface interface where the density or composition of a layer of the subsurface changes. At mid-point 732, trajectory 728 reflects on ray 734 that propagates to receiver 102b. Mid-point 732 lies equidistant between source 104 and receiver 102b. Mid-point 132 provides a CDP, also called a CMP for sources and receivers symmetrically disposed about point 732 along floor 712.

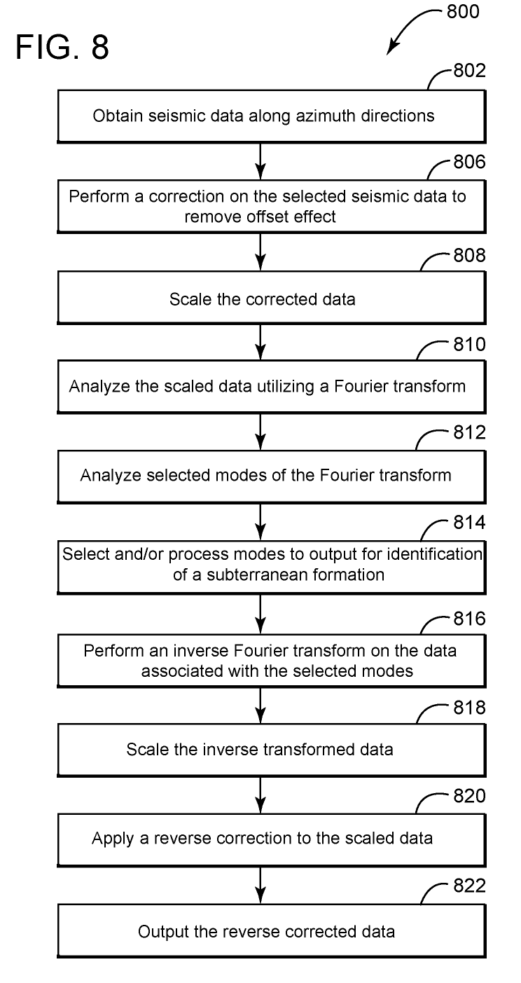

FIG. 8 illustrates a flow chart of an example method 800 of characterizing a subterranean formation to identify anisotropic behavior utilizing azimuthal data in accordance with some embodiments of the present disclosure. The steps of method 800 are performed by a user, various computer programs, models configured to process or analyze seismic data, or any combination thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing system.” For illustrative purposes, method 800 is described with respect to data based on OBC acquisition exploration area 100 of FIG. 1; however, method 800 may be used to characterize a subterranean formation utilizing azimuthal data for any suitable seismic data set.

Method 800 starts, and at step 802, the computing system obtains seismic data along azimuth directions from a seismic exploration or survey. For example, a seismic data set is generated by signals received by receivers 102 shown in FIGS. 1 and 7. The data is processed into azimuth directions and the azimuthal data is obtained by the computing system. The computing system selects only a portion of the data set for analysis based on an incidence angle range. For example, incidence angles from approximately five to forty degrees may be selected. In some embodiments, incidence angles up to approximately sixty degrees or larger may be selected. Further, the computing system determines the stage in the processing flow at which to obtain the data. For example, the data may be obtained at migration, residual move out (RMO), wavelet decay curve matching, post stack residual de-multiple, 4D OVT matching, spectra offset balancing, trim statics, or AVO. The selection of processing stage is based on ease of obtaining, expected further correction required, or any other suitable characteristic.

At step 806, the computing system performs a correction on the selected seismic data to remove the offset effect. For example, as discussed with reference to FIG. 2, an AVO plot is generated from the selected seismic data and the data is flattened. Flattening includes subtracting the average amplitude, or subtracting the AVO trend (intercept and gradient) from the data. For example, the Rüger equation is modified to remove the gradient and intercept shown in Equation (2) reproduced below:

R=Acos2(φ−φ₀)sin²θ (2)

The selected seismic data may additionally be smoothed to remove outliers.

At step 808, the computing system scales the corrected data by a factor such as sin²θ or 1/sin²θ. Scaling removes the effects of the incidence angle on the corrected data. For example, as shown with reference to FIG. 4C, an AVAz plot is generated to illustrate the effect of scaling. For scaling, the Rüger equation is modified as shown in Equation (3) reproduced below:

R=Acos2(φ−φ₀) (3)

At step 810, the computing system analyzes the scaled data utilizing a Fourier transform. Depending on the irregularity of the data, a FFT or an IFT is selected. For example, for irregular sampling illustrated in amplitude 510 shown with reference to FIG. 5A, an IFT is performed. Applying an IFT to the data indicates anisotropic areas or directions of the data in particular modes.

At step 812, the computing system analyzes selected modes of the Fourier transform. For example, if the data complies with Rüger' s equation, modes two and four are of interest for identifying anisotropic regions. However, because the Rüger equation is only an approximation, odd modes exhibit energy. Further, information for all selected modes is retained and analyzed. For example, modes other than modes two and four are analyzed for artifacts and other features that provide information about the subterranean formation.

At step 814, the computing system selects and/or processes one or more modes to output as an image for identification of subterranean formations or fractures. For example, mode two may exhibit events that indicate areas of anisotropy. Corrections are performed on the data prior to generating an image to correct the output. Corrections include lowering the offset/angle threshold for the data, scaling the root mean squared (RMS) output, forcing some modes, for example mode zero, to zero, smoothing the data, or any other suitable corrections. Steps 802, 806, 808, 810, 812 and 814 may be referred to as an azimuthal decomposition or a decomposition method or process.

At step 816, the computing system performs an inverse Fourier transform on the data associated with the selected modes. If an IFT was utilized in step 810, the computing system utilizes an inverse IFT on the selected modes. The inverse FFT or IFT transforms the data back into the time domain. For example, an inverse IFT may be performed on the data output to mode two selected in step 814. Modes may be transformed independently to enable improved interpretation of resulting data.

At step 818, the computing system scales the inverse transformed data by a factor that is the inverse of the factor used in step 808. For example, if in step 808 a scaling factor such as 1/sin²θ was utilized, then the computing system scales the time domain data by sin²θ.

At step 820, the computing system applies the reverse of the correction performed on the data in step 806 to the scaled data. For example, the computing system may “unflatten” the data and add the average amplitude or the AVO trend (intercept and gradient) to the data.

At step 822, the computing system outputs the reverse corrected data, which may be referred to as reconstructed seismic data. Steps 816, 818, 820 and 820 may be referred to as an “azimuthal reconstruction” method or process. By performing the azimuthal reconstruction on the modes selected in step 814, each mode will consist of a stack, or one trace per bin. The stacks can be further edited, de-noised, or processed prior to final reconstruction back into gathers. Method 800 allows analysis of seismic data in the time domain following reconstruction. This analysis can provide correction of bias or other issues in the data and may result in anisotropic information with lower noise (higher SNR).

Additionally, modifications, additions, or omissions may be made to method 800 without departing from the scope of the present disclosure. For example, the order of the steps may be performed in a different manner than that described and some steps may be performed at the same time. Additionally, each individual step may include additional steps without departing from the scope of the present disclosure.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate.

Reference throughout the specification to “one embodiment,” “some embodiments,” or “an embodiment” means that a particular feature, structure or characteristic described in connection with an embodiment is included in at least one embodiment of the subject matter disclosed. Thus, the appearance of the phrases “in one embodiment,” “in some embodiments,” or “in an embodiment” in various places throughout the specification is not necessarily referring to the same embodiment. Further, the particular features, structures or characteristics may be combined in any suitable manner in one or more embodiments.

What is claimed is:

1. A method for analyzing seismic data, the method comprising:
obtaining seismic data along a plurality of azimuth angles from a receiver;
performing a correction to the seismic data to remove an offset effect, the offset effect based on a distance between the receiver and a seismic source; and
analyzing the corrected seismic data for an anisotropic region indicative of a subterranean fracture.

2. The method of claim 1, wherein analyzing the corrected seismic data includes scaling the corrected seismic data.

3. The method of claim 2, wherein scaling the corrected seismic data is based on a Rüger equation.

4. The method of claim 2, wherein scaling the corrected seismic data includes dividing the corrected data by sin² of an incidence angle.

5. The method of claim 2, wherein analyzing the corrected seismic data further includes:
performing a Fourier transform on the scaled seismic data;
analyzing a plurality of modes of the Fourier transform; and
selecting a particular mode of the plurality of modes for identification of the anisotropic region of the subterranean formation.

6. The method of claim 5, wherein the Fourier transform is an irregular Fourier transform based on an irregular sampling of the data.

7. The method of claim 5, further comprising:
performing an inverse Fourier transform on data associated with the selected particular mode;
scaling the transformed data;
applying a reverse correction to the scaled transformed data; and
outputting the reverse corrected data.

8. The method of claim 5, wherein the particular mode is mode two.

9. The method of claim 8, further comprising analyzing a mode other than mode two for an artifact.

10. The method of claim 1, wherein the seismic data is based on an irregular common offset vector (COV) geometry.

11. The method of claim 1, further comprising generating an image of the subterranean formation based on the identified anisotropic region.

12. A seismic processing system, comprising:
a receiver configured to receive seismic data;
a computing system configured to:
obtain seismic data along a plurality of azimuth angles from the receiver;
perform a correction to the seismic data to remove an offset effect, the offset effect based on a distance between the receiver and a seismic source; and
analyze the corrected seismic data for an anisotropic region indicative of a subterranean fracture.

13. The system of claim 12, wherein analyzing the corrected seismic data includes scaling the corrected seismic data.

14. The system of claim 13, wherein scaling the corrected seismic data is based on a Rüger equation.

15. The system of claim 13, wherein scaling the corrected seismic data includes dividing the corrected data by sin² of an incidence angle.

16. The system of claim 13, wherein analyzing the corrected seismic data further includes:
performing a Fourier transform on the scaled seismic data;
analyzing a plurality of modes of the Fourier transform; and
selecting a particular mode of the plurality of modes for identification of the anisotropic region of the subterranean formation.

17. The system of claim 16, wherein the Fourier transform is an irregular Fourier transform based on an irregular sampling of the data.

18. The system of claim 16, further comprising:
performing an inverse Fourier transform on data associated with the selected particular mode;
scaling the transformed data;
applying a reverse correction to the scaled transformed data; and
outputting the reverse corrected data.

19. A non-transitory computer-readable medium, comprising:
computer-executable instructions carried on the computer-readable medium, the instructions, when executed, causing a processor to:
obtain seismic data along a plurality of azimuth angles from a receiver;
perform a correction to the seismic data to remove an offset effect, the offset effect based on a distance between the receiver and a seismic source; and
analyze the corrected seismic data for an anisotropic region indicative of a subterranean fracture.

20. The non-transitory computer-readable medium of claim 19, wherein analyzing the corrected seismic data includes scaling the corrected seismic data.
